(19) United States
(12) Patent Application Publication
(10) Pub. No.: US 2006/0230287 A1
(43) Pub. Date: Oct. 12, 2006

(54) Business method and system for security and personal communication

(76) Inventor: Patrick C. Taylor, Montgomery, AL (US)

Correspondence Address: BUSH INTELLECTUAL PROPERTY LAW GROUP, LLC, P.O. BOX 381146, BIRMINGHAM, AL, 35238, US

(21) Appl. No.: 11/100,321

(22) Filed: Apr. 6, 2005

(51) Int. Cl. H04K 1/00

(52) U.S. Cl. 713/186

(57) ABSTRACT

A method and system for security and personal communication providing users a hand-held biomarker communication device for anonymously and securely contacting each other. A first user places the thumb or finger on the scanner of the communication device, points the device at another user, and presses the scanner. A biomarker identifier associated with the thumb print or finger print is transmitted to the device of the other user. The other user can connect the device to the USB port of a computer and place the thumb or finger on the scanner. The biomarker identifier creates a hyperlink to the first user's website on the computer screen and the other user can access information about the first user, including contact information. Income is generated from this method by charging a fee for providing the biomarker communication device, subscribing to an internet based communication service, providing a website, e-mail address, toll-free telephone number, joint registration of multiple biomarker identifiers, and the sale of advertising on users' websites.

### FIELD OF THE INVENTION

The present invention relates to the commercialization of personal communication, and more particularly to the commercial facilitation of individuals meeting each other and/or providing personal information to each other through reliable and secure electronic media for a variety of purposes, while providing telecommunication and advertising services.

### BACKGROUND OF THE INVENTION

Numerous interpersonal-introduction signaling systems have been created to assist people in meeting or contacting each other. Some systems use devices designed to transmit and receive a particular code. Some use local control units to receive personal data from a plurality of user memory devices, and compare the personal data of one user with another user to determine compatibility based upon predetermined standards. In some systems individuals use their license plate numbers for identification through a centralized dating service. Many of these systems are created to provide internet dating services through personal computers, using software programs to match individuals based upon personal data and preferences. Some of these computer based systems provide real-time physical location of users so that they can meet face to face in a specific geographic area, and may also provide a third-party investigator to provide a background search of a particular user.

In the practical use of these personal contact systems there are problems with security and adequate identification of users. Biometric identification methods and devices are known but have not been adapted in a simple or practical way to personal contacting systems to make them commercially feasible. The known contacting systems and devices are designed mainly for dating services. However, the demand for personal contacting extends beyond the desire to date someone. The demand also extends to a plurality of financial and medically related transactions. This unmet demand represents a large commercial opportunity that extends far beyond personal contacting limited to dating. What is needed, therefore, is a simple, reliable, and secure commercial method and system of electronically mediated personal contacting that allows people to meet each other and which facilitates security, financial, legal, and medical transactions of individuals. Such a business system and method could generate substantial additional income through associated telecommunication and advertising services.

### SUMMARY OF THE INVENTION

The present invention is a secure, reliable system, method, and apparatus for commercializing personal contacting among an unlimited number of people and businesses. A personal hand-held communication device is provided to users which has a power supply, biomarker reader, transmitter/receiver, computer, and an input/output interface. The hand-held device is activated by connecting the device to a computer to access the server of the communication service provider. A user's biomarker is scanned on the hand-held device, transmitted to the server, and becomes a secure, reliable identifier for each user. The service provider provides an internet website, an email address, and a toll free telephone number for each user. All users who have registered or subscribed for the services of the communication service provider can contact each other using the hand-held communication device. For example, a first male user who sees a female that he would like to meet can contact that female with his hand-held communication device if that female is also a registered user with a personal hand-held communication device. If the biomarker is a thumb print, then the first user places his thumb on the scanner of his communication device and presses the scanner which activates his communication device to transmit a biomarker identifier to the female user's communication device. The female user can then connect her communication device to a computer which displays the biomarker identifier on the female user's computer screen. The male user's biomarker identifier is also displayed as a hyperlink which allows the female user to access the male user's website.

When the female user connects to the male user's website, the female user can access whatever information the male user is willing to provide. After reviewing the data on the male user, the female user can choose whether or not to contact the male user. If the female user chooses to contact the male user she is provided with the male user's email address or toll free telephone number or both. While connected to the male user's website, one or more advertisements of one or more vendors can be displayed on the male user's website for the female user to view.

Income is generated in the above-described system and method by obtaining fees from users for the personal hand-held communication device, registration with the communication service provider, a personal website, an email address, and on-going use of a toll free telephone number. In addition, a substantial amount of revenue is generated by providing advertising to vendors on each user's website.

Businesses can also register with the communication service provider to record the biomarker of a given user for access to a secure database of the user. A user can then transfer confidential information to a business by activating the biomarker mechanism of his or her hand-held communication device to transmit his or her identifier to the communication device of the business. For example, a user may wish to provide a bank with financial information, or a clinic with medical records, or simply perform a credit card transaction. Additional revenue is obtained in this case when a business registers the biomarker of a given user who is a customer.

An advantage of the present invention is a system, method, and apparatus that provides immediate, secure, and anonymous contact with strangers.

Another advantage is a system, method, and apparatus that provides anonymous, reliable, and secured evaluation of a contactor by a contactee.

Another advantage is a convenient, hand-held electronic contacting device secured by biomarker identification.

Another advantage is the transmission of personal, financial, legal, and medical information secured by electronic biomarker registration and biomarker identification.

Another advantage is credit card transactions secured by electronic biomarker registration and biomarker identifier transmission.

Another advantage is a system, method, and apparatus for providing secure anonymous contacting among users and secure transmission of personal data that is simple and inexpensive to implement.

Another advantage is a business system and method that generates income not only from providing secure anonymous electronic contacting services and secure electronic transmission of personal data, but also from providing website advertising and telecommunications.

### BRIEF DESCRIPTION OF THE DRAWINGS

FIG. 1 is a structural diagram of the personal hand-held communication device of the present invention.

FIG. 2 is a system level diagram of the personal hand-held communication device.

FIG. 3 is a functional diagram of the personal hand-held communication device.

FIG. 4 is a circuit diagram of the personal hand-held communication device.

FIG. 5 shows the system for personal communication of the present invention.

FIG. 6 shows the method of personal communication of the present invention.

### DETAILED DESCRIPTION OF THE PREFERRED EMBODIMENTS

While the following description details the preferred embodiments of the present invention, it is to be understood that the invention is not limited in its application to the details of construction and arrangement of the parts illustrated in the accompanying drawings, since the invention is capable of other embodiments and of being practiced in various ways.

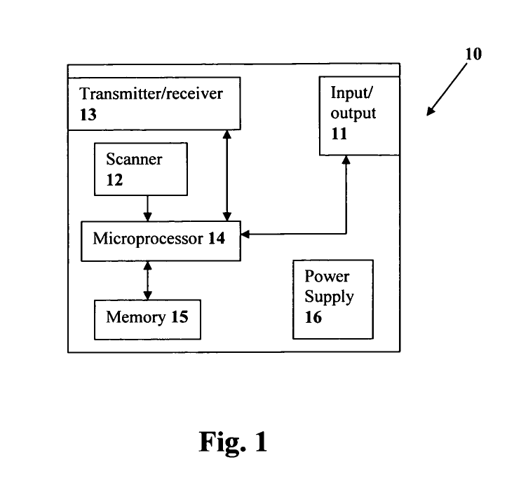

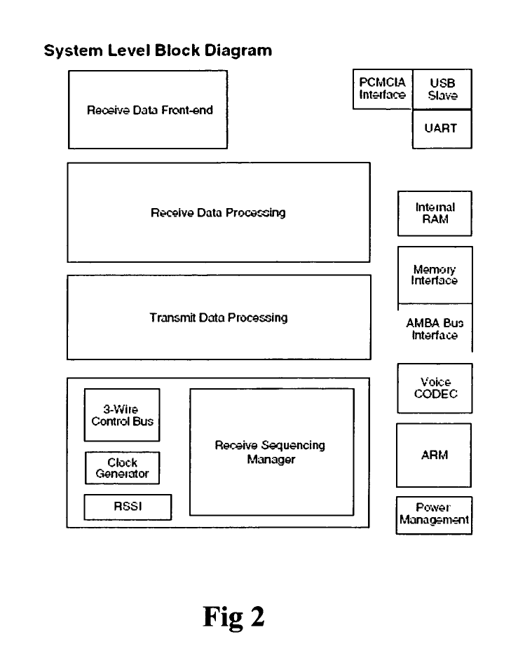

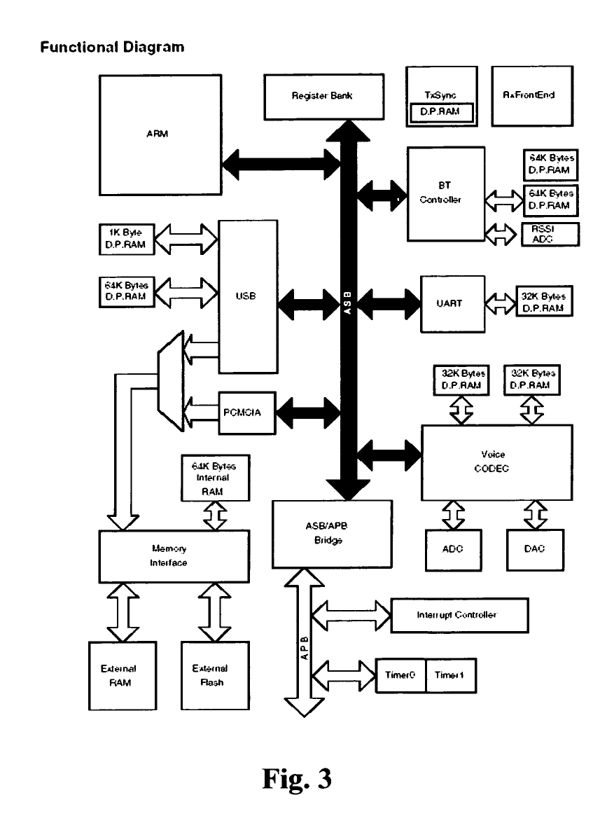

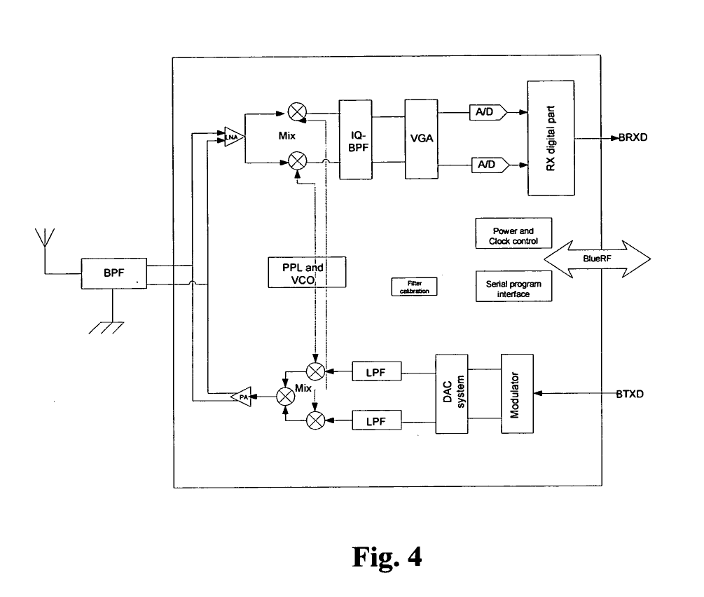

FIG. 1 is a structural diagram of the personal hand-held communication device 10 of the present invention. Communication device 10 has an input/output connector 11, such as, for example, a USB connector. Communication device 10 has a biomarker reader, such as, for example, a scanner 12 which will scan and record finger prints or thumb prints. Device 10 also has a transmitter/receiver 13, microprocessor 14, memory 15, and power supply 16. Components 11-16 may comprise standard computer hardware and software known in the art. For example, USB technology useful for connecting device 10 to a computer to program device 10 or transmit information from device 10 to a computer is JumpDrive® TouchGuard™ USB Flash Drive. Wireless technology useful for transmitting and receiving information among a plurality of devices 10 is Blutooth™. FIG. 2 illustrates the system level elements of device 10 in more detail. FIG. 3 illustrates the functional elements of device 10 in more detail. FIG. 4 shows a circuit diagram of device 10. Device 10 transmits a biomarker identifier signal only when the biomarker is read by the scanner while simultaneously pressing the scanner.

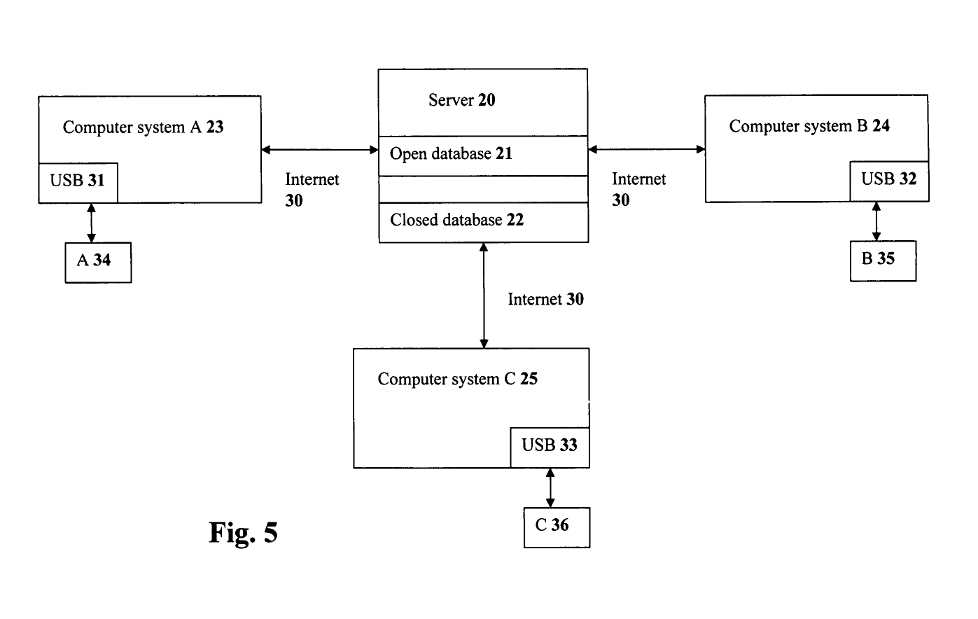

FIG. 5 illustrates the system for personal communication of the present invention. A communication services provider provides a server 20 to users. The server 20 can be accessed by users from computer systems, such as, for example, personal computers. The computer systems comprise microprocessors, memory, display devices, such as printers and monitors, input devices, such as a keyboard and a mouse, USB ports, communication devices, such as cable, telephone, or wireless transmission, all internet-based communication devices, and all software necessary for operating all the above hardware devices, all of which hardware and software are well known in the art.

A plurality of users, such as users A34, user B35 and user C36 can access server 20 by inserting personal communication device 10 into USB ports 31, 32, 33, respectively. Users A, B, and C must also place a thumb or finger on scanner 12 in order for device 10 to read a finger or thumb print as a biomarker. Computer systems A, B, and C will then connect users A, B, and C to server 20 where they can register or subscribe to the services provided by the personal communication services provider, thereby activating device 10. Computers A, B, and C can connect to server 20, preferably, by means of the internet 30, or related communication systems.

The finger print biomarker provides a secure identification of a user on server 20 and on device 10. Device 10 cannot transmit information without a user first placing the finger or thumb on the scanner. In the activation process of device 10, the biomarker of a user is transferred from device 10 to server 20 so that the biomarker transferred to server 20 is associated with a specific device 10. Server 20 then provides Users A, B, and C each with a website, an e-mail address, and a toll-free telephone number after the biomarker is recorded and the user purchases the service. Users are then provided data storage which can be open 21 or closed 22.

Users can enter information into the open 21 or closed 22 databases, or both. This information can be, for example, names, addresses, photographs, phone numbers, e-mail addresses, medical records, business records, and the like. In some cases a user such as user C can also register the biomarkers of other users, such as users A and B, so that the biomarkers of users A and B are associated with the biomarker of user C's registration or subscription.

In use, user A, for example, can contact user B by transmitting a signal from user A's device 10 which is received by user B's device 10. In order to do this, user A must place a finger on scanner 12 on device 10 and press down, thereby transmitting an identifying signal to user B's device 10. A signal will not be transmitted from user A's device 10 if the scanner does not scan user A's fingerprint. User A's device 10 will recognize only user A's fingerprint biomarker and no one else's. Thus, the identifying signal sent by user A to user B is unique to user A and to no one else.

User B can connect user B's device 10 to computer system 24 through USB port 32. User B then places user B's finger on scanner 12 and then has access to user A's website on server 20. User B can then access user A's information in open database 21 without further authorization. User B would be provided with, for example, user A's e-mail address, toll-free telephone number, photographs, and biography. User B can then contact user A if user B so desires. User B can also provide user A access to user B's information on user B's website.

In some cases, a user may wish to authorize certain other users to have access to information in a closed database 22. Such secured information may include medical records, financial records, legal records and the like. In this case, user A can authorize user C to register user A's biomarker along with user C's biomarker on server 20, in user C's account. When user A contacts user C by placing user A's finger on scanner 12 and pressing, user C after receiving user A's identifier, can insert user C's device 10 into user C's computer system 25 via USB port 33. After user C then places user C's finger on scanner 12, user C can then access user A's website. User C can then retrieve information from user A's open database 21 and secure closed data base 22. Although FIG. 5 shows only user A, B, and C, an unlimited number of users can participate in the system.

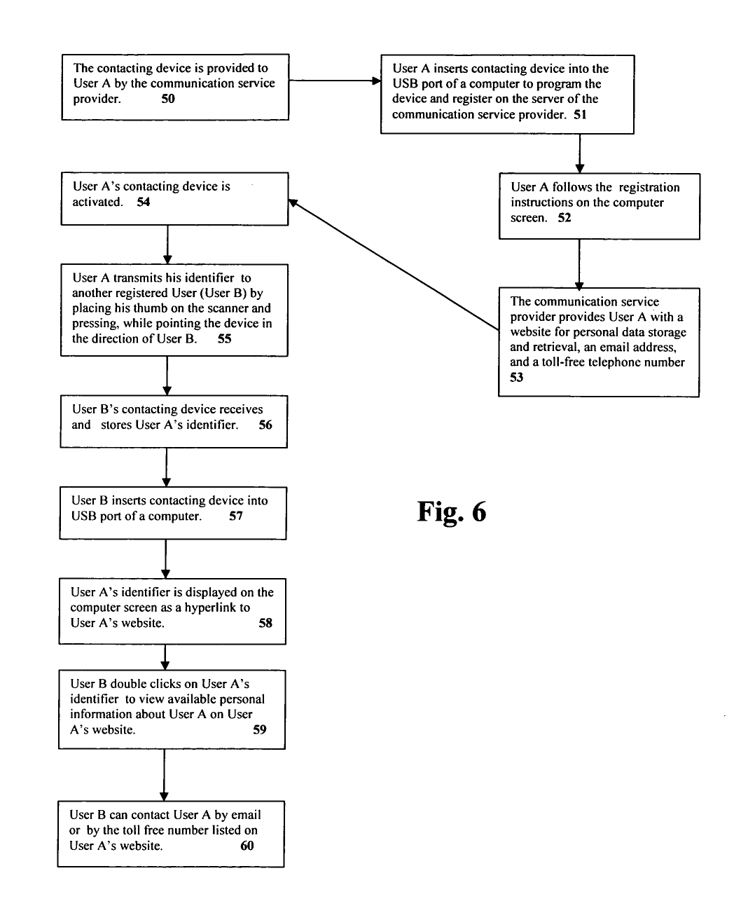

FIG. 6 shows the method of personal communication of the present invention. The personal hand-held communication device 10 of the present invention is provided to user A by the communication service provider (step 50). User A inserts device 10 into the USB port of a computer and places user A's biomarker over scanner 12 so that scanner 12 can read and record user A's biomarker (step 51). The biomarker is, preferably, a thumb or fingerprint. User A's computer is connected to the server 20 of the communication service provider and user A's biomarker is registered on server 20 while user A completes the rest of the registration and subscription instructions shown on user A's computer screen for the services of the communication service provider (step 52). The communication service provider provides user A with a website for data storage and retrieval, an e-mail address, and a toll-free telephone number (step 53). User A can access user A's website any time by connecting device 10 to the USB port of user A's computer and simultaneously placing user A's biomarker on scanner 12. User A can add or delete data in data storage 21 and 22 as desired. User A's contacting device is activated for use (step 54).

User A contacts another registered user (user B) anonymously by placing user A's biomarker on scanner 12 and pressing scanner 12 while pointing device 10 towards user B (step 55). User B's contacting device 10 receives and stores user A's identifier (step 56). User B inserts contacting device 10 into the USB port of user B's computer while placing user B's biomarker on scanner 12 (57). User A's identifier is displayed on user B's computer screen as a hyperlink to user A's website (58). User B uses the hyperlink to connect to user A's website to view information of user A's choice, such as an e-mail address, a toll-free telephone number, a photograph, and a biography (step 59). User B can choose to contact user A and to provide user A access to user B's website to access information of user B's choice (step 60).

User A can provide user B with user A's biomarker so that user B can register user A's biomarker at the same time user B registers user B's biomarker, and completes the subscription or application of the communication services provider. When user A contacts user B as described above, user B can access user A's information on user A's website that user B could not otherwise access if user B had not registered user A's biomarker with user B's biomarker.

### EXAMPLE 1

Bob purchases a personal hand-held communication device (PHCD) of the present invention from a communication services provider (CSP). Bob connects the PHCD into the USB port of his computer and a page or screen appears on his computer monitor. This page provides instructions to Bob on how to scan his biomarker fingerprint on the PHCD, register the biomarker with the CSP, and subscribe to the communication services of the CSP. After scanning his thumb on the PHCD the scanning information is processed by the microprocessor and memory in the PHCD to create a biomarker identifier which is stored in Bob's PHCD and is stored in the CSP server database during registration. Bob pays for a website, an e-mail address, and a toll-free telephone number service. With the website in place Bob enters his telephone number, e-mail address, photograph, and biographical data into an open database. Bob also enters his medical records, legal records, and business records into a closed database. When Bob has completed his registration his PHCD has been activated and is ready for use. Bob agrees to let the CSP display advertising on his website for a reduction in registration fees.

### EXAMPLE 2

Bob is eating lunch at a restaurant and sees an attractive woman that he would like to meet. He places his thumb on the scanner of his PHCD, points the PHCD in the direction of the woman and presses the scanner. This will send a radio signal (wireless) to the PHCD of the woman, assuming she is a registered user of CSP's services and has an activated PHCD. The radio signal that is transmitted by Bob is coded to identify Bob's fingerprint and is, thus, a biomarker identifier. This signal is received by the woman's PHCD and stored in her PHCD for later retrieval. She has, thus, been contacted anonymously and securely by Bob. At some later time the woman can insert her PHCD into the USB port of her computer, place her thumb or finger on the scanner and access her website. The website will display all the biomarker identifiers her PHCD received, including Bob's. The biomarker identifier appears as a hyperlinked code, such as a number. The woman clicks on Bob's hyperlinked biomarker identifier and her computer is connected to Bob's website. She can then access whatever information Bob put into his open database. She can choose to contact Bob directly by e-mail or phone or both. She can also ignore the contact and delete Bob's biomarker identifier. She can also authorize Bob to access her website so that Bob can review her open database and contact her directly. This has all been done anonymously. The process is also secure and reliable because only Bob can send the contact signal to the woman. Only Bob's fingerprint on the scanner will allow signal transmission when the scanner is pressed. The scanned fingerprint is compared to the stored fingerprint in PHCD. If there is no match, no signal can be transmitted, thereby insuring reliability and security. Bob's website will display advertising to the woman as she views Bob's website.

### EXAMPLE 3

Bob would like to be able to use his PHCD to provide his medical records to his physician. He can authorize the CSP to register his biomarker identifier with his physician's CSP account. The physician pays the CSP a fee to register Bob's biomarker identifier in the physician's account. When Bob goes to the physician's office, he places his thumb on the scanner of his PHCD, points his PHCD at the physician's PHCD, and presses the scanner. Bob's biomarker identifier is transmitted to the physician's PHCD. The physician connects his PHCD to his computer and places his thumb or finger on the scanner. Bob's biomarker identifier is then displayed as a hyperlink on the physician's computer screen, which allows the physician to access Bob's website. The physician can then obtain medical records from Bob's closed database. In a similar manner, Bob's credit card information can be supplied to the physician to pay the physician's fee.

The foregoing description has been limited to specific embodiments of this invention. It will be apparent, however, that variations and modifications may be made by those skilled in the art to the disclosed embodiments of the invention, with the attainment of some or all of its advantages and without departing from the spirit and scope of the present invention. For example, the personal hand-held communication device and the method and system of the present invention can be used to transfer information securely in any desired situation. As an example, a user going through an airport could connect the communication device to a reader or computer in the airport to verify the identity of the user. Similarly, information and identification can be securely and anonymously transmitted in any type of financial transaction, storage and retrieval of any kinds of records, or any kind of identification process. The biomarker may also be a retinal or DNA pattern.

It will be understood that various changes in the details, materials, and arrangements of the parts which have been described and illustrated above in order to explain the nature of this invention may be made by those skilled in the art without departing from the principle and scope of the invention as recited in the following claims.

1. A personal hand-held communication device comprising:
a) a scanner for reading a biomarker;
b) a microprocessor with associated memory for receiving and processing biomarker information from said scanner to create and store a biomarker identifier;
c) an input/output device for transferring and receiving information to and from a computer; and
d) a transmitter and receiver for transmitting and receiving one or more said biomarker identifiers associated with said biomarker.

2. The communication device of claim 1 wherein said biomarker is a finger or thumb print.

3. The communication device of claim 1 wherein said input/output device is a USB connector.

4. The communication device of claim 1 wherein said biomarker identifier forms a hyperlink to connect to a website.

5. A personal hand-held communication device comprising:
a) a scanner for reading a finger print or thumb print biomarker;
b) a microprocessor with associated memory for receiving and processing biomarker information from said scanner to create and store a biomarker identifier, said biomarker identifier forming a hyperlink to connect to a website;
c) a USB input/output device for transferring and receiving information to and from a computer; and
d) a wireless transmitter and receiver for transmitting and receiving one or more said biomarker identifiers associated with said biomarker.

6. A method of personal contacting comprising the steps of:
1) providing a plurality of users a biomarker communication device having a power supply, a transmitter/receiver, a computer, a scanner and an input/output interface;
2) said users subscribing to a communications service provider and submitting information to said service provider;
3) assigning a biomarker identifier to said each user, said biomarker identifier associated with each user's biomarker;
4) one or more first users transmitting said biomarker identifiers to one or more other users; and
5) said other users accessing said one or more first users' information from said communication service provider by means of said biomarker identifiers.

7. The method of claim 6 further comprising the step of said first user placing the thumb or finger on said scanner and pressing said scanner to transmit said biomarker identifier to one or more other users.

8. The method of claim 6, further comprising the step of connecting said biomarker communication device to a computer system whereby said biomarker identifier forms a hyperlink allowing said other users to access said first users' information.

9. The method of claim 8 further comprising the step of said other user placing the thumb or finger on said scanner in order for said biomarker identifier to form a hyperlink.

10. The method of claim 6, further comprising the step of said other users choosing to contact or not contact said first users as a result of said communication service provider providing contact information of said first users to said other users.

11. The method of claim 8 further comprising the step of said communication service provider providing said each user with a website allowing said other users to access said first users' information.

12. A method of personal contacting comprising the steps of:
1) providing to a plurality of users a biomarker communication device having a power supply, a transmitter/receiver, a computer, a scanner, and an input/output interface;
2) said users subscribing to a communications service provider and submitting information to said service provider, said service provider providing said each user with a website;
3) assigning a biomarker identifier to said each user said biomarker identifier associated with each user's biomarker;
4) one or more first users transmitting said biomarker identifier to one or more other users; and
5) said other users accessing said one or more first users' information from said one or more first users' website by connecting said biomarker communication device to a computer system whereby said biomarker identifier forms a hyperlink.

13. The method of claim 12 further comprising the step of said first user placing the thumb or finger on said scanner and pressing said scanner to transmit said biomarker identifier to one or more other users.

14. The method of claim 12 further comprising the step of said other user placing the thumb or finger on said scanner in order for said biomarker identifier to form a hyperlink.

15. The method of claim 12, further comprising the step of said other users choosing to contact or not contact said first users as a result of said communication service provider providing contact information of said first users to said other users.

16. A method of personal contacting comprising the steps of:
1) providing to a plurality of users a biomarker communication device having a power supply, a transmitter/receiver, a computer, a scanner and an input/output interface;
2) said users subscribing to a communication service provider and submitting information to said service provider, said service provider providing said each user with a website;
3) assigning a biomarker identifier to said each user said biomarker identifier being associated with each user's finger or thumb print;
4) one or more first users transmitting said biomarker identifier to one or more other users, said first user placing the thumb or finger on said scanner and pressing said scanner to transmit said biomarker identifier; and
5) said other users accessing said one or more first users' information from said one or more first users' websites by connecting said biomarker communication device to a computer system whereby said biomarker identifier forms a hyperlink, said other user placing the thumb or finger on said scanner in order for said biomarker identifier to form a hyperlink.

17. The method of claim 16, further comprising the step of said other users choosing to contact or not contact said first users as a result of said communication service provider providing contact information of said first users to said other users.

18. A system for personal contacting, comprising:
a) a biomarker communication device having a power supply, a transmitter/receiver, a computer, a scanner and an input/output interface;
b) a server operated by a communications service provider;
c) a computer system for each user connected to said server by a communications system;
d) a biomarker identifier in said biomarker communication device and on said server for each user, said biomarker identifier being associated with each user's biomarker and each user's information stored on said server;
e) one or more first users contacting one or more other users anonymously and securely by transmitting said biomarker identifier from said first user's biomarker communication device to said other user's biomarker communication device; and
f) one or more other users connecting said biomarker communication device to said computer system by said input/output interface and accessing said one or more first users' information stored on said server.

19. The system of claim 18 wherein said first user places the thumb or finger on said scanner and presses said scanner to transmit said biomarker identifier to one or more other users' biomarker communication devices.

20. The system of claim 18, wherein connecting said biomarker communication device to a computer system causes said biomarker identifier to form a hyperlink, allowing said other users to access said first users' information from said server.

21. The system of claim 20 wherein said other user places the thumb or finger on said scanner in order for said biomarker identifier to form a hyperlink.

22. The system of claim 18, wherein said other users choose to contact or not contact said first users as a result of said communication service provider providing contact information of said first users to said other users.

23. The system of claim 18 wherein said communication service provider provides said each user with a website allowing said other users to access said first users' information on said website.

24. A system of personal contacting, comprising:
a) a biomarker communication device having a power supply, a transmitter/receiver, a computer, a scanner, and an input/output interface;
b) a server operated by a communications service provider;
c) a computer system for each user connected to said server by a communications system;
d) a biomarker identifier in said biomarker communication device and on said server for each user, said biomarker identifier being associated with each user's biomarker and each user's information stored on each user's website on said server;
e) one or more first users contacting one or more other users anonymously and securely by transmitting said biomarker identifier from said first users biomarker communication device to said other user's biomarker communication device;
f) said first user placing the thumb or finger on said scanner and pressing said scanner in order to transmit said biomarker identifier to one or more other users' biomarker communication devices; and
g) one or more other users connecting said biomarker communication device to said computer system by said input/output interface and accessing said one or more first users' information stored on said website through a hyperlink formed by said biomarker identifier, said other user placing the thumb or finger on said scanner in order for said biomarker identifier to form said hyperlink.

25. The system of claim 24, wherein said other users choose to contact or not contact said first users as a result of said communication service provider providing contact information of said first users to said other users.

26. A method of generating income from the method of claim 6, comprising the steps of:
1) charging a fee for the step of providing said biomarker communication device;
2) charging a fee for the step of subscribing to said communication service provider;
3) charging a fee for said service provider providing a website to a user; and
4) charging a fee for said service provider providing an e-mail address to a user.

27. The method of claim 26, further comprising the steps of:
1) charging a fee for providing a toll-free telephone service to a user; and
2) charging a fee to other users to register first users' biomarkers in order for other users to access secure information about said first users when said other users are contacted by said first user.

28. The method of claim 27, further comprising the step of charging a fee to advertisers for advertisements provided to said other users who access information from said first users.

29. A method of generating income from the method of claim 12 comprising the steps of:
1) charging a fee for the step of providing said biomarker communication device;
2) charging a fee for the step of subscribing to said communication service provider;
3) charging a fee for said service provider providing a website to a user; and
4) charging a fee for said service provider providing an e-mail address to a user.

30. The method of claim 29, further comprising the steps of:
1) charging a fee for providing a toll-free telephone service to a user; and
2) charging a fee to other users to register first users' biomarkers in order for other users to access secure information about said first users when said other users are contacted by said first user.

31. The method of claim 30, further comprising the step of charging a fee to advertisers for advertisements provided to said other users who access information from said first users.

32. A method of generating income from the method of claim 16, comprising the steps of:
1) charging a fee for the step of providing said biomarker communication device;
2) charging a fee for the step of subscribing to said communication service provider;
3) charging a fee for said service provider providing a website to a user; and
4) charging a fee for said service provider providing an e-mail address to a user.

33. The method of claim 32, further comprising the steps of:
1) charging a fee for providing a toll-free telephone service to a user; and
2) charging a fee to other users to register first users' biomarkers in order for other users to access secure information about said first users when said other users are contacted by said first user.

34. The method of claim 33, further comprising the step of charging a fee to advertisers for advertisements provided to said other users who access information from said fist users
